(19) United States
(12) Patent Application Publication
(10) Pub. No.: US 2016/0217429 A1
(43) Pub. Date: Jul. 28, 2016

(54) SELECTIVE NOTIFICATION OF USER AVAILABILITY STATUS

(71) Applicant: Google Inc., Mountain View, CA (US)

(72) Inventor: Kevin Kin-wai LAU, San Jose, CA (US)

(21) Appl. No.: 14/605,976

(22) Filed: Jan. 26, 2015

(51) Int. Cl. G06Q 10/10

(52) U.S. Cl. CPC G06Q 10/1095; G06Q 10/107

(57) ABSTRACT

A system that provides selective notification of user availability may include a processor circuit. The processor circuit may be configured to receive an availability status update of a user for a period of time. The processor circuit may be configured to update an aggregate calendar with the availability status update of the user for the period of time, where the aggregate calendar includes availability statuses of a set of users including the user. The processor circuit may be further configured to determine at least one user of the set of users that is likely to be interested in the availability status update of the user based at least in part on a user relation criterion. The processor circuit may be further configured to provide an indication of the availability status update of the user for the period of time on a calendar of the at least one user.

### TECHNICAL FIELD

The present description relates generally to user availability status, and more particularly, but not exclusively, to selective notification of user availability status.

### BACKGROUND

Out-of-office automatic reply (“auto-reply”) messages may be used in email systems to notify a sender of an email that the recipient is presently out of the office. The content of the auto-reply message may indicate the period of time that the recipient will be out of the office and/or may provide some insight to the sender as to when the recipient is likely to respond to the email. However, if the sender had not sent an email to the recipient, the sender would not have received the auto-reply message and therefore may not have been notified that the recipient is presently out of the office.

### SUMMARY

The disclosed subject matter relates to a computer-implemented method for selective notification of user availability status. The computer-implemented method includes receiving, using one or more processors, an availability status update of a user for a period of time. The computer-implemented method further includes updating, using the one or more processors, an aggregate calendar with the availability status update of the user for the period of time, wherein the aggregate calendar includes availability statuses of a set of users that includes the user. The computer-implemented method further includes determining, using the one or more processors, at least one user of the set of users that is likely to be interested in the availability status update of the user based at least in part on a user relation criterion. The computer-implemented method further includes providing, using the one or more processors, an indication of the availability status update of the user for the period of time on a calendar of the at least one user of the set of users.

The disclosed subject matter also relates to a device that includes at least one processor circuit that is configured to receive a request for a calendar of a user of a plurality of users of an organization. The at least one processor circuit is further configured to determine a subset of the plurality of users whose availabilities are of interest to the user based at least in part on a structure of the organization. The at least one processor circuit is further configured to retrieve the availabilities of the subset of the plurality of users from an aggregate calendar for the plurality of users of the organization. The at least one processor circuit is further configured to populate the calendar of the user with indications of the availabilities of the subset of the plurality of users exclusive of other users of the plurality of users. The at least one processor circuit is further configured to provide, for display, the calendar of the user.

The disclosed subject matter also relates to a non-transitory machine-readable medium embodying instructions that, when executed by a machine, cause the machine to perform a method that may include receiving an availability status update from a user of a plurality of users of an organization. The method may further include filtering the plurality of users to identify a subset of the plurality of users that are directly or indirectly associated with the user in an organizational structure of the organization. The method may further include determining a plurality of recent contacts of the user that are distinct from the subset of the plurality of users. The method may further include providing a calendar update that reflects the availability status update of the user to the subset of the plurality of users and the plurality of recent contacts.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement a system for selective notification of user availability status in accordance with one or more implementations.

FIG. 2 illustrates an example server for a system supporting selective notification of user availability status in accordance with one or more implementations.

FIG. 3 illustrates an example calendar management data flow in a system supporting selective notification of user availability status in accordance with one or more implementations.

FIG. 4 illustrates a flow diagram of an example process for a system supporting selective notification of user availability status in accordance with one or more implementations.

FIG. 5 illustrates a flow diagram of an example process for a system supporting selective notification of user availability status in accordance with one or more implementations.

FIG. 6 illustrates a flow diagram of an example process for a system supporting selective notification of user availability status in accordance with one or more implementations.

FIG. 7 illustrates an example organizational structure in a system for selective notification of user availability status in accordance with one or more implementations.

FIG. 8 illustrates example email and messaging status content in a system for selective notification of user availability status in accordance with one or more implementations.

FIG. 9 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In some instances, structures and components are shown in block diagram form in order to avoid obscuring the concepts of the subject technology.

The subject system for selective notification of user availability status utilizes an aggregate calendar for an organization that aggregates the user availability statuses, such as out-of-office statuses, for all of the users within the organization, such as all of the employees of the organization. The subject system then accesses the aggregate calendar to selectively notify a user of only the availability statuses, and/or updates thereto, of other users that are likely to be of interest to the user, without inundating the user with the availability statuses of all of the users within the organization. In one or more implementations, the aggregate calendar may be a collection of calendar related information as stored, for example, in a database. The availability statuses of the users of interest may be provided as indications on a calendar of the user.

In one or more implementations, the subject system utilizes a filtering system that filters the users within the organization, for example based on one or more user relation criteria or user relation filters, to determine the users who are likely to be interested in a particular user's availability status update, such as when the user identifies a period of time that they will be out of the office. For example, a user relation criterion may be applied to an organizational structure of the organization to identify one or more group(s) of users within the organization who are directly and/or indirectly associated with the user and therefore are likely to be interested in the user's availability status update, such as one or more persons that the user is working for, e.g. one or more bosses or supervisors, and/or one or more persons that work for the user, e.g. one or more direct reports. Similarly, another user relation criterion may be applied to the organizational structure, or other organizational information, to identify one or more group(s) of users within the organization who are teammates and/or collaborators of the user, and therefore are also likely to be interested in the user's availability status update.

In one or more implementations, a complex user relation criterion may be applied to combine the previous two user relation criteria to identify one or more group(s) of users within the organization who are either (a) associated with teammates and/or collaborators of the users' immediate boss(es) and/or direct reports or (b) immediate boss(es) and/or direct reports associated with teammates and/or collaborators of the user. Thus, user relation criterion (a) identifies teammates and/or collaborators that either the user's boss(es) (or reports) are working with, and user relation criterion (b) identifies the boss(es) and/or reports of people the user is working with.

In one or more implementations, another user relation criterion may be applied to email and instant messaging history of the user to identify a group of users who are recent contacts, and/or frequent contacts of the user, who are therefore also likely to be interested in the user's availability status update, such as based on communication frequency and patterns. The subject system may then selectively notify only the determined users of the user's availability status update, such as by adding an indication to the calendars of the determined users.

In one or more implementations, the content of the availability status update of the user may be used to determine which of the other users are likely to be interested in the availability status update. For example, teammates and/or collaborators of the user are likely to be interested in when the user will be away at lunch, while the recent contacts of the user may not be interested in knowing when the user will be away at lunch. Similarly, collaborators who work with a team may be interested in being notified of a team event that will result in a substantial portion of the team being out of office e.g. so the collaborators may plan accordingly.

In one or more implementations, context of the email/messaging communications and/or organizational relationships/associations can be used to further group interested users, and to further customize the notifications sent to the interested users, and/or provided on calendars of the interested users, according to the groupings. The amount of detail provided to different groups of users for the availability status update (e.g. reason for being out, duration, contact info, etc.) may be customized according to the different groupings. For example, details about a team being out of office due to a team event may be useful to collaborators of the team, but may not be useful to other members of the organization, and/or may not be appropriate to share with, for example, outside vendors. Similarly, out-of-office messages, such as emails, can be customized according to the groupings of the users. Alternatively, or in addition, out-of-office messages can be customized for users who are not associated with the organization, such as users who are not employees of the organization. For example, an outside vendor who regularly communicates with the user may be provided a customized message with potentially more, less, and/or different detail than someone who has little or no previous contact with the user.

In one or more implementations, when a user's availability status indicates that the user is out-of-office, the user can identify an alternate contact to be reached while the user is out of the office. In this manner, relevant contacts may be provided with someone who can readily assist them or help them get in contact with the user who is out-of-office. In one or more implementations, a user can set customized out-of-office messages that can be sent, for example, via email based on whether a person trying to reach the user has already been notified of the user's out-of-office status and/or based on the specific groupings of the interested users who were notified of the out-of-office status. For example, teammates of the user may receive a customized email message indicating that the user is reachable via mobile phone in the case of an emergency. In contrast, people who were not notified of the user's out-of-office status may receive an email redirecting them to an alternate contact that can assist them or help them get in contact with the out-of-office user. In one or more implementations, teammates and/or collaborators of the user may be sent a customized email message identifying another teammate who can assist while the user is out of the office. However, those who are not teammates and/or collaborators of the user may only receive contact information for the user's assistant. Similarly, customized away messages for instant messaging may be set by the system based on the user's availability status.

In one or more implementations, the subject system may utilize the aggregate calendar for the organization to create a personalized availability calendar for a user, where other users who are likely to be interested in the availability status of the user are treated as subscribers of the user's availability calendar. Alternatively and/or in addition, the aggregate calendar may be individually filtered when provided and/or displayed to each user, such that each user only views the availability statuses of the other users that are likely to be of interest to the user. In this implementation, users are treated as subscribers (or followers) of the aggregate calendar, where the aggregate calendar is individually filtered for each subscriber. The filtering may occur either before or when the aggregate calendar is provided and/or displayed to a subscriber. In one or more implementations, the subject system may create and/or updates individual user calendars as a task separate from when the users request to view their calendars.

Thus, the subject system facilitates an aggregate calendar for tracking user availability statuses, such as out-of-office statuses, of an entire organization. The system can be used by a user to notify relevant co-workers about an update to their availability status from a centralized location, without needing to individually target messages to other coworkers or sending a message to a wider audience than necessary. In this manner, the subject system allows for better communication between teams and easier scheduling of meetings between teams. The aggregate calendar of the subject system may also be used by organizations to track the availability statuses of employees. For example, employees may indicate within their availability status whether they are sick, working from home, on vacation, etc. The organization can then automatically utilize the availability statuses of the aggregate calendar to appropriately account for employee sick time, vacation time, unapproved time-off, etc.

In one or more implementations, the subject system may be used by a team of an organization to create their own calendar, and the subject system can automatically include the members of the team as users who are likely interested in the team's calendar, such as based on an organizational structure of the organization. In this case, when team members move around between teams, their calendars will automatically update based on the organizational structure (or other organizational information) to remove, e.g. not display, calendar events from their previous team and instead add, e.g. display, calendar events from their new team. Similarly, collaborators who were working together, but have stopped working together for a predetermined period of time, may see their calendars automatically update to remove the availability statuses of previous collaborators.

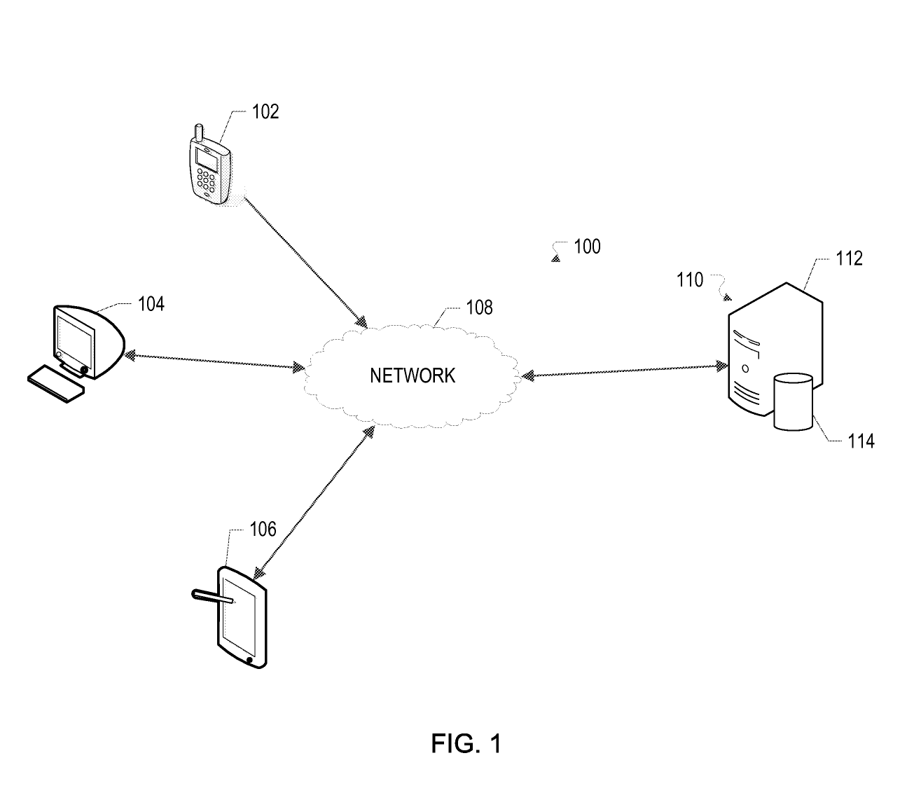

FIG. 1 illustrates an example network environment 100 which may implement a system for selective notification of user availability status in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The example network environment 100 may include a number of electronic devices 102, 104, 106 communicably connected to a server 110, such as by the network 108. In another example, some or all of the electronic devices 102, 104, 106 may be communicably connected to one another, such as by the network 108, and some or all of the electronic devices 102, 104, 106 may not be communicably connected to the server 110. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

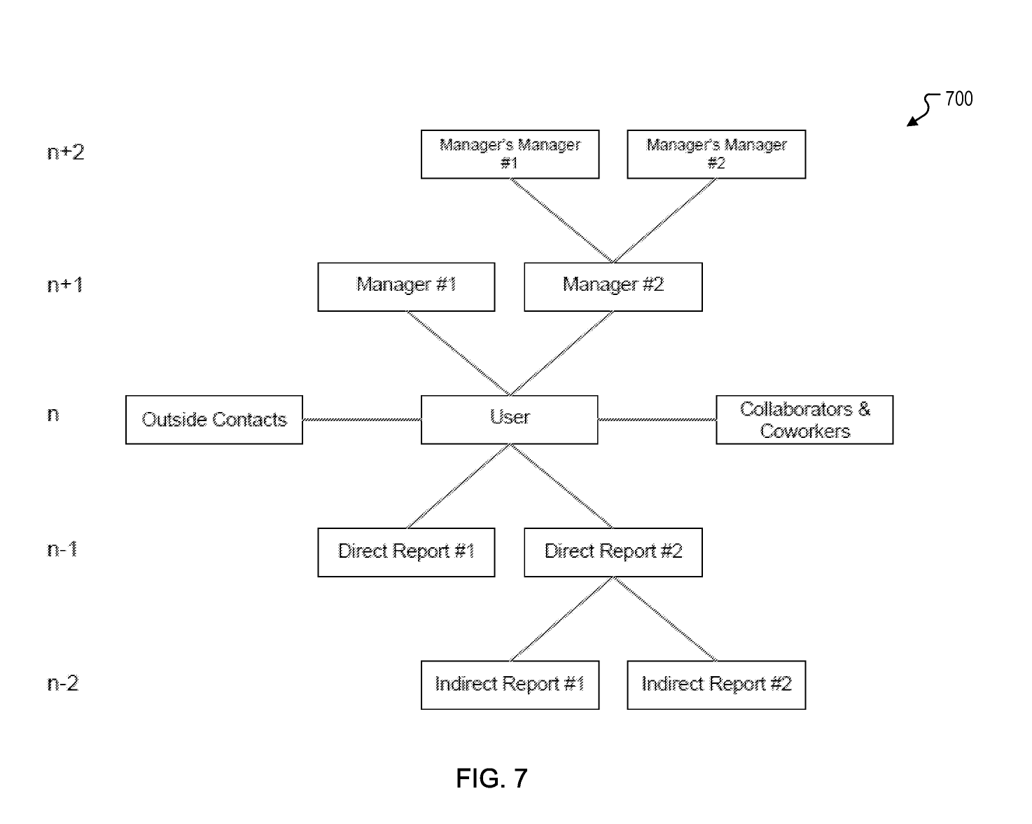

The electronic devices 102, 104 and 106 can be computing devices such as laptop or desktop computers, smartphones, tablet computers, wearable devices, such as eyeglasses or watches that have one or more processors coupled thereto and/or embedded therein, televisions or other displays with one or more processors coupled thereto and/or embedded therein, or other appropriate computing devices that can be used to for displaying a web page, a web application, a mobile application, or another graphical user interface. In the example of FIG. 1, the electronic device 102 is depicted as a smartphone, the electronic device 104 is depicted as a desktop computer, and the electronic device 106 is depicted as a tablet device. In one or more implementations, the electronic devices 102, 104, 106 may be, or may include all or part of, the electronic system that is discussed further below with respect to FIG. 7.

The server 110 may be a single computing device such as a computer server, and/or the server 110 may represent one or more computing devices (such as a cloud of computers and/or a distributed system) that are communicatively coupled, such as communicatively coupled over the network 108, that collectively, or individually, perform one or more functions that can be performed server-side. The one or more computing devices of the server 110 may be geographically collocated and/or the one or more computing devices of the server 110 may be disparately located. The server 110 may be coupled with various databases, storage services, or other computing devices. The server 110, and the coupled databases, storage services, or other computing devices may be geographically collocated, or may be disparately located.

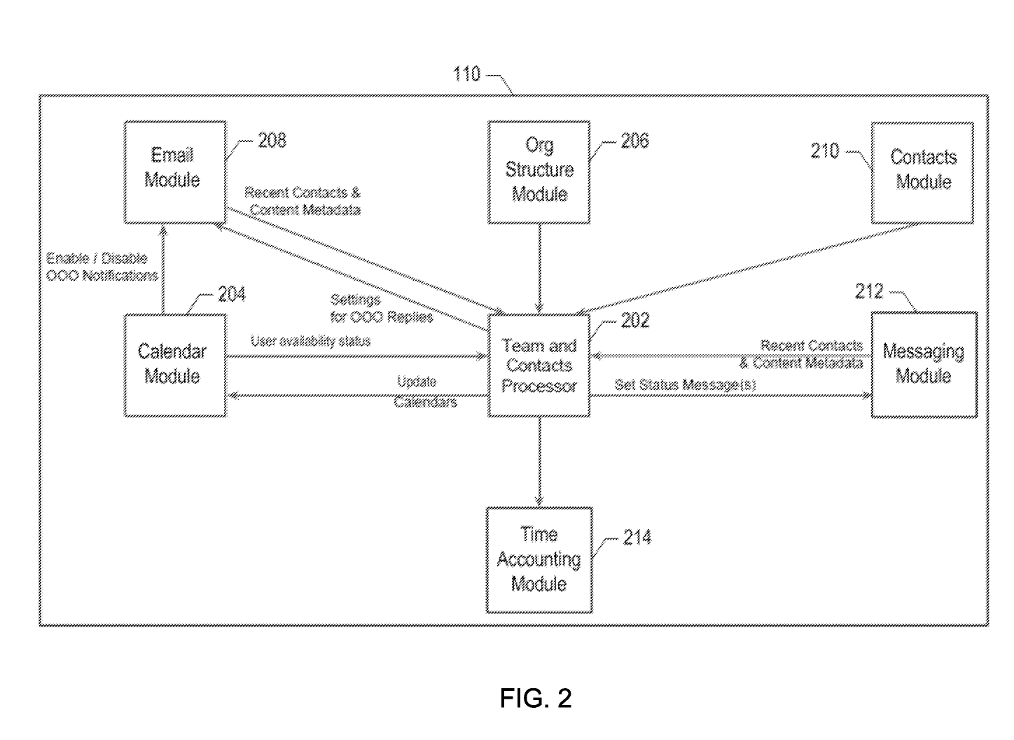

In one or more implementations, the server 110 includes at least one processor circuit 112 and a data store 114. The at least one processor circuit 112 executes computer instructions stored in the data store 114, for example, to provide selective notification of user availability status. In one or more implementations, the data store 114 may store the computer instructions on non-transitory computer-readable medium. In one or more implementations, the server 110 may be, or may include all or part of, the electronic system that is discussed further below with respect to FIG. 7. An example server 110 is discussed further below with respect to FIG. 2.

The server 110 may host a web server that is communicatively coupled to client applications, such as web browsers and or web-based applications of client devices (e.g., the electronic devices 102, 104 or 106) via the network 108. In one or more implementations, all or part of the subject system may be a standalone system and/or may be integrated into one or more of a calendar system, an email system, an accounting system, a time-accounting system, a human resources system, a messaging system, and/or a back-office system, one or more of which may be hosted at server 110. In another example, the subject system may be hosted all or in part at server 110 and may be communicatively coupled to one or more remote servers hosting one or more of the calendar system, the email system, the accounting system, the time-accounting system, the human resources system, the messaging system, and/or the back-office system (e.g., one or more remote servers) over one or more networks (e.g., the network 108).

FIG. 2 illustrates an example server 110 in a system supporting selective notification of user availability status in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided. As previously discussed with respect to FIG. 1, the server 110 may represent one or more computing devices that may be communicably coupled, such as over one or more networks. Alternatively, the server 110 may represent a single computing device and/or one or more processors thereof.

The server 110 may include a team and contacts processor 202, a calendar module 204, an organizational structure module 206, an email module 208, a contacts module 210, a messaging module 212, and a time accounting module 214. In one or more implementations, the server 110 may only include the team and contacts processor 202, the calendar module 204, and the organizational structure module 206. In one or more implementations, the server 110 may only include the team and contacts processor 202, the calendar module 204, the organizational structure module 206, and the email module 208. However, any other variations of the depicted components may also be used.

The calendar module 204 may store and/or maintain an aggregate calendar that includes availability statuses of users within an organization, such as employees of the organization. In one or more implementations, the availability status of a user may indicate the user's availability for a period of time, such as available, unavailable, out-of-office, etc. In one or more implementations, the availability status may further include additional details and/or information regarding the user's availability, such as the location of the user for the period of time, the reason the user is out of the office or unavailable, etc. In one or more implementations, the calendar module 204 may also store and/or maintain individual calendars for each of the users associated with the organization, such as in addition to the aggregate calendar for the organization. The individual calendar of a user may include the user's availability statuses. In one or more implementations, the calendar module 204 may receive calendar updates from the team and contacts processor 202 and may update the respective calendars appropriately.

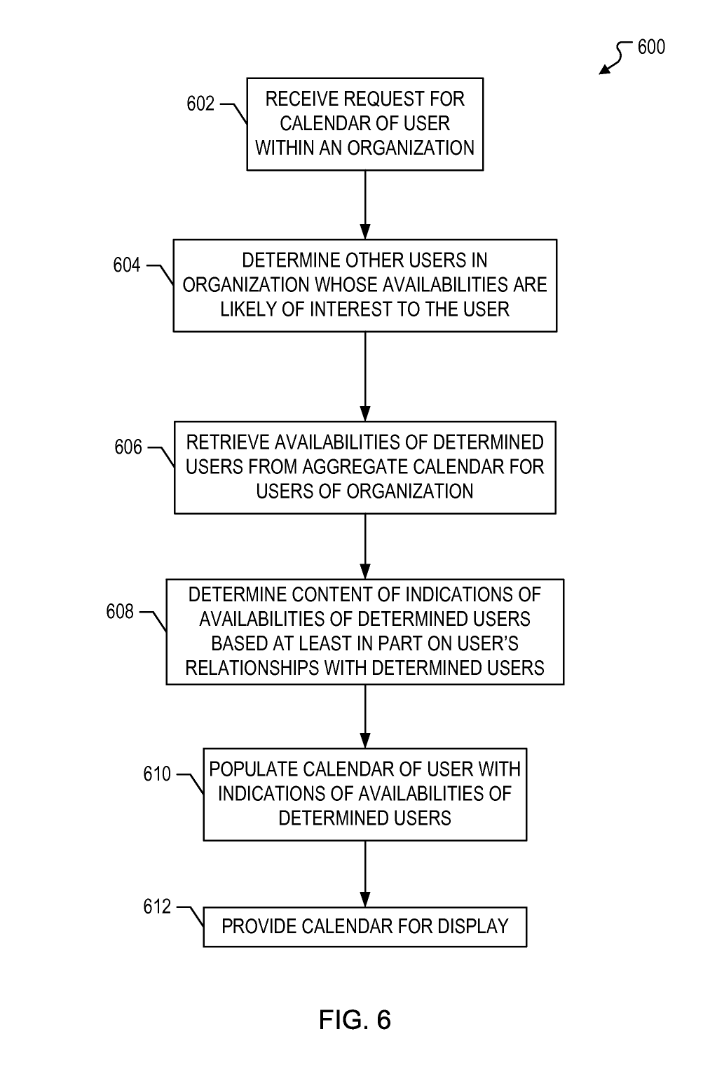

The organizational structure module 206 may store and/or maintain organizational structure information for the organization. The organizational structure information may indicate relationships and/or associations between the users, such as management relationships, collaboration relationships, teammate relationships, etc. In one or more implementations, the organizational structure module 206 may be, and/or may include, information retrieved via a lightweight directory access protocol (LDAP). An example organizational structure is discussed further below with respect to FIG. 6.

In one or more implementations, the organizational structure module 206 may provide all or part of the organizational structure information to the team and contacts processor 202, such as in response to a request therefor. In one or more implementations, the organizational structure module 206 may receive an identifier of a user and a user relation criterion (or user relation filter), such as from the team and contacts processor 202. In response, the organizational structure module 206 may provide, to the team and contacts processor 202, a list of users who satisfy the user relation criterion with respect to the user. For example, the user relation criterion may correspond to managers of the user, and the organizational structure module 206 may provide a list of users who are direct and/or indirect managers of the user.

In one or more implementations, the organizational structure module 206 may receive a query for one or more users or organizational entities and, in response, the organizational structure module 206 may provide, to the team and contacts processor 202, information about the users and/or organizational entities. The team and contacts processor 202 may then utilize the received information to determine the organization structure and then apply a user relation criterion to determine the list of users who are direct and/or indirect managers of the user.

The email module 208 may be used to set email auto-replies that correspond to a user's availability status, such as an out-of-office auto-reply, an in-meeting auto-reply, etc. In one or more implementations, one or more of the user's availability statuses may not be associated with an email auto-reply, such as when the availability status indicates that the user is available. The email module 208 may store and/or provide different email auto-replies for different user relation criterion for each user availability status. For example, with regard to an availability status of out-of-office, the email module 208 may provide a first automatic email response for users who satisfy a user relation criterion corresponding to collaborators, and a second automatic email response for users who satisfy a user relation criterion corresponding to teammates. In one or more implementations, the calendar module 204 and/or the team and contacts processor 202 may enable, disable, and/or configure the auto-replies for each user relation criterion and each user availability status. Thus, a user may set different email auto-replies for each availability status and for each user relation criterion corresponding to each availability status.

The email module 208 may also store, maintain, and/or provide information describing recent contacts and email content metadata to the team and contacts processor 202. In one or more implementations, the email content metadata may include information generated from a context and/or content analysis of received and/or sent emails. The context analysis may determine, for example, whether the emails are social or work related communications. In one or more implementations, the context and/or content analysis may also analyze attachments of the emails. The team and contacts processor 202 may use the recent contacts information and/or email content metadata to identify other users who may be interested in the user's availability statuses, and/or updates thereto. In one or more implementations, a user may need to opt-in in order to allow the email module 208 to provide the user's recent contacts information and/or email content metadata to the team and contacts processor 202. In one or more implementations, the system may be configured such that contacts that send primarily social and promotional emails do not receive any out-of-office replies for a user who is not available.

The contacts module 210 may store and/or maintain contacts associated with each of the users. The contacts module 210 may provide all or part of a user's contacts information to the team and contacts processor 202. The team and contacts processor 202 may use the user's contacts information to identify other users, e.g. recent contacts, who may be interested in the user's availability status and/or updates thereto. In one or more implementations, a user may need to opt-in in order to allow the contacts module 210 to provide the user's contacts information provided to the team and contacts processor 202. The contacts module may be a part of, or may communicate with, a social networking service to provide information that can be used to identify users by their contact information.

The messaging module 212 may be used to set messaging service status messages that correspond to a user's messaging availability status, such as online, away, not available, or invisible, etc. The messaging module 212 may store and/or provide different messaging service status messages for different user relation criterion and for each user messaging availability status. For example, with regard to an availability status of away or not available, the messaging module 212 may display a first messaging service status message to users who satisfy a user relation criterion corresponding to collaborators such as out-of-office or busy, and a second messaging service status message to users who satisfy a user relation criterion corresponding to teammates such as in-meeting or vacation. In one or more implementations, the team and contacts processor 202 may enable, disable, and/or configure the messaging service status messages for each user relation criterion and each user availability status.

The messaging module 212 may also store, maintain, and/or provide information describing recent contacts and messaging content metadata to the team and contacts processor 202. The team and contacts processor 202 may use the recent contacts information and/or messaging content metadata to identify other users who may be interested in the user's availability status, and/or updates thereto. In one or more implementations, a user may need to opt-in in order to allow the messaging module 212 to provide the user's recent contacts information and messaging/or content metadata to the team and contacts processor 202.

The time accounting module 214 may receive user availability statuses from the team and contacts processor 202. The time accounting module 214 may utilize the user availability statuses to perform one or more time accounting functions with respect to the organization. For example, the user availability statuses may indicate when users associated with the organization, such as employees, are sick, when users associated with the organization are on vacation, etc., and the time accounting module 214 may use this information to verify that the sick days, vacation days, etc. are being properly accounted for.

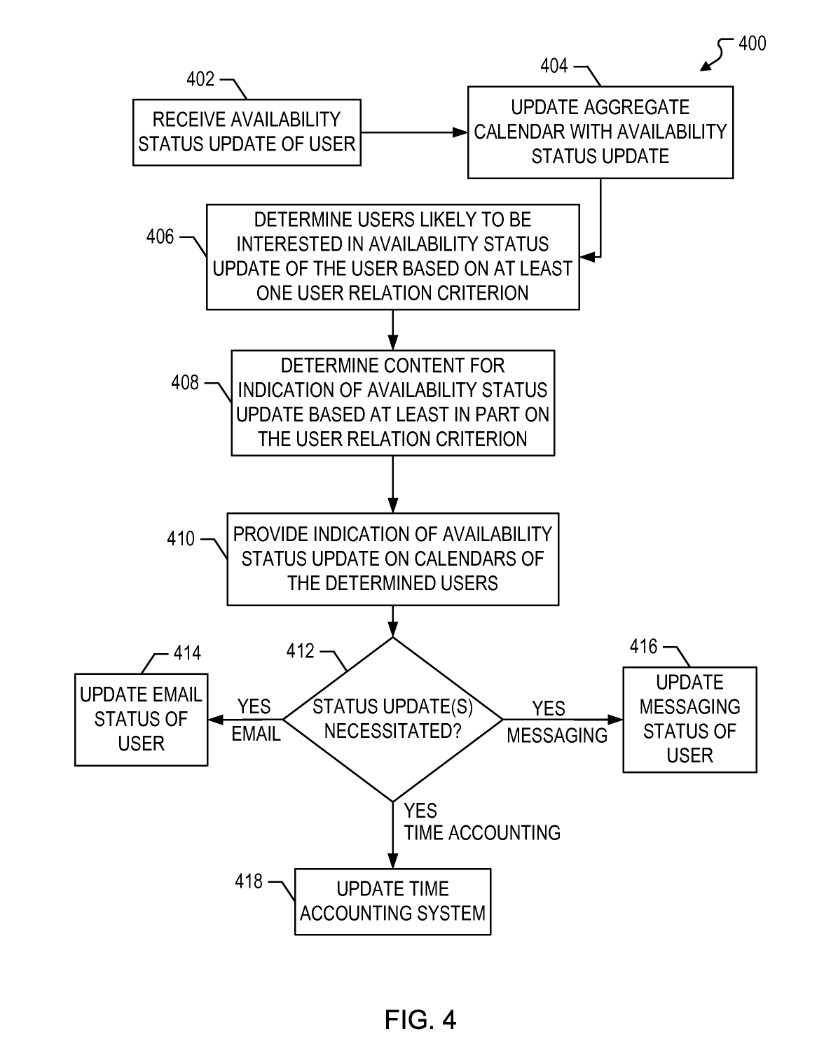

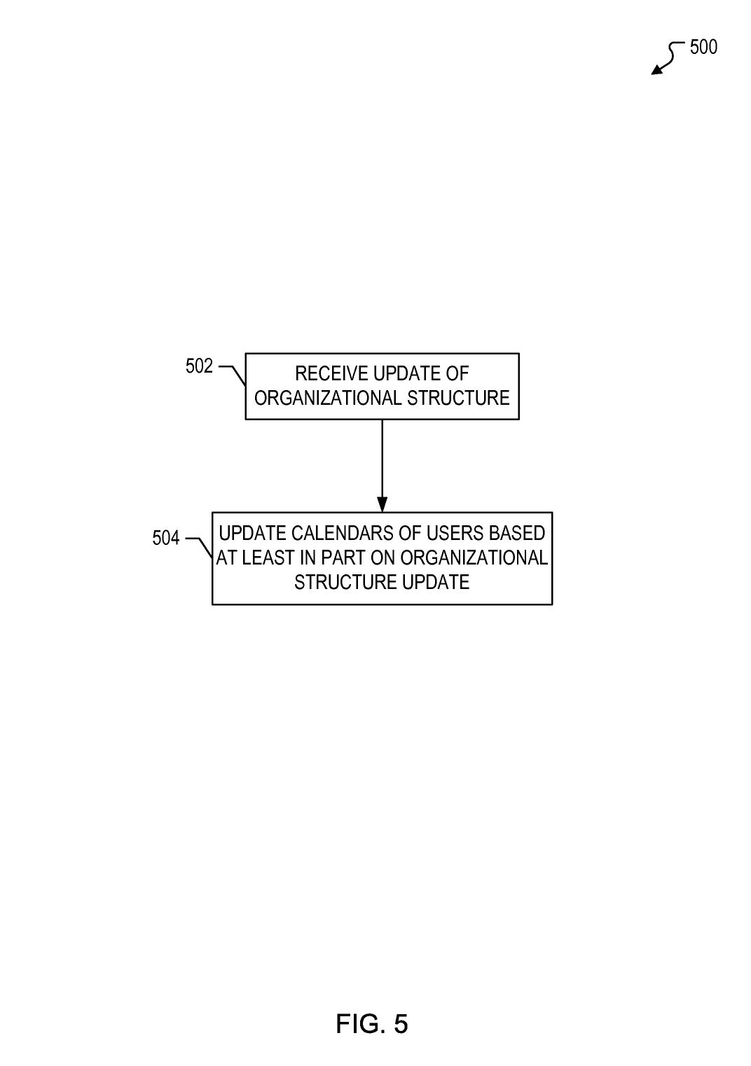

The team and contacts processor 202 may retrieve data from, may provide updates to, and/or may configure one or more of the calendar module 204, the organizational structure module 206, the email module 208, the contacts module 210 and/or the messaging module. The team and contacts processor 202 may retrieve and process data from one or more of the modules 204-212 to identify which users are likely to be interested in other users availability statuses and/or updates thereto. For example, the team and contacts processor 202 may use information received from the organizational structure module 206 to identify users who are likely to be interested in a user's availability status updates because they are directly or indirectly associated with the user in the organizational structure of the organization. The team and contacts processor 202 may use information received from the email module 208 and/or the messaging module 212 to identify users who may be unassociated with the user in the organizational structure but are likely to be interested in the user's availability status because of the frequency of their recent correspondences with the user. Upon receiving an availability status update for a user, the team and contacts processor 202 may determine the relevant users, send calendar updates for the relevant users to the calendar module 204, and provide settings for the user's automatic replies to the email module 208. Example processes of the server 110 are discussed further below with respect to FIGS. 4 and 5.

In one or more implementations, one or more of the team and contacts processor 202, the calendar module 204, the organizational structure module 206, the email module 208, the contacts module 210, the messaging module 212, and the time accounting module 214 may be implemented in software (e.g., subroutines and code) and/or hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. In one or more implementations, some or all of the depicted components may share hardware and/or circuitry, and/or one or more of the depicted components may utilize dedicated hardware and/or circuitry. Additional features and functions of these modules according to various aspects of the subject technology are further described in the present disclosure.

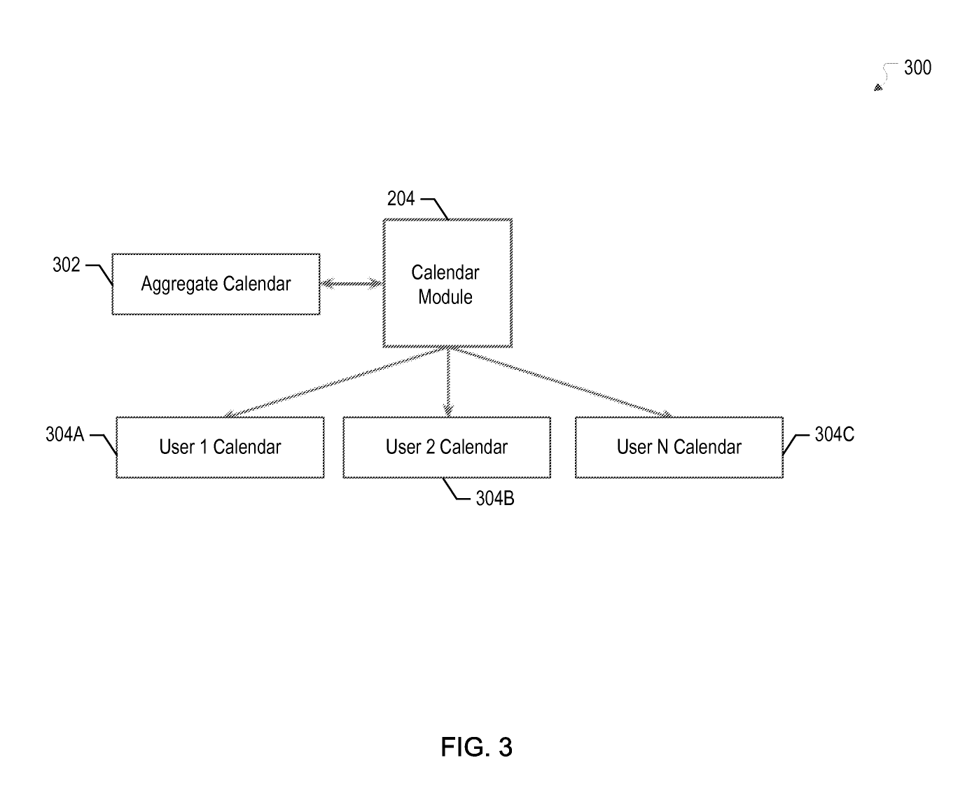

FIG. 3 illustrates an example calendar management data flow 300 in a system supporting selective notification of user availability status in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The calendar management data flow 300 includes the calendar module 204 that maintains an aggregate calendar 302 for the organization, as well as user calendars 304A-C for individual users of the organization. In one or more implementations, the calendar module 204 may generate one or more of the user calendars 304A-C by filtering the aggregate calendar 302 to only include the availability statuses that are likely to be of interest to the users corresponding to the user calendars 304A-C, e.g. including their own availability statuses. In this instance, all of the users may be referred to as subscribers of the aggregate calendar, which is then individually filtered for each user. In one or more implementations, the calendar module 204 may generate one or more of the user calendars, such as the user calendar 304A, based on the calendars of the other users that are subscribed to by the corresponding user. Thus, the user calendar 304A may be populated with the availability statuses of the other user calendars that are subscribed to the by corresponding user.

FIG. 4 illustrates a flow diagram of an example process 400 for a system supporting selective notification of user availability status in accordance with one or more implementations. For explanatory purposes, the example process 400 is primarily described herein with reference to server 110 of FIGS. 1 and 2; however, the example process 400 is not limited to the server 110 of FIGS. 1 and 2, and the example process 400 may be performed by one or more components of the server 110, such as, for example, one or more of the team and contacts processor 202 and/or modules 204-214. Further for explanatory purposes, the blocks of the example process 400 are described herein as occurring in serial, or linearly. However, multiple blocks of the example process 400 may occur in parallel. In addition, the blocks of the example process 400 may be performed a different order than the order shown and/or one or more of the blocks of the example process 400 may not be performed.

In block 402, the server 110 receives an availability status update of a user within an organization. For example, a user interacting with the electronic device 102 may transmit, such as via a calendar application, an availability status update indicating that the user will be out of the office for a period of time, such a number of days, hours, minutes, or any period of time. The availability status update may further indicate whether the user will be on vacation, out on sick leave, parental leave, etc. The availability status update may further indicate alternate contacts for the user with respect to different user relation criteria, e.g. for the period of time while the user will be out of the office.

In block 404, the server 110 updates the aggregate calendar 302 with the availability status update of the user. For example, the team and contacts processor 202 may provide the user availability status update to the calendar module 204. In block 406, the server 110 determines other users who are likely to be interested in the availability status update of the user based on at least one user relation criterion. In one or more implementations, the server 110 may determine the users who are directly and/or indirectly related and/or associated with the user in an organizational structure of the organization provided by the organizational structure module 206, such as managers and/or direct reports of the user. In one or more implementations, the server 110 may determine users who are recent contacts of the user as indicated by the email module 208, the messaging module 212, and/or the contacts module 210. In one or more implementations, the server 110 may determine the teammates and/or collaborators of the user, such as based on document revision histories, organizational information and/or messaging histories.

In one or more implementations, the server 110 may determine a frequency at which the user corresponds with one or more of the other users, such as via email and/or via messaging. The server 110 may determine that one or more of the other users are likely to be interested in the user's availability status update when the frequency at which the user corresponds with the one or more other users satisfies a frequency threshold. In one or more implementations, the frequency may be determined based on the number of correspondences that the user sends to the one or more other users over a period of time and/or the number of correspondences that the user receives from the one or more other users over a period of time.

In block 408, the server 110 determines content for the indications of the availability status update of the user based at least in part on the user relation criterion. For example, if the user relation criterion corresponds to recent external contacts of the user, the content of the indication may only indicate that the user is out of the office, but when the user relation criterion corresponds to teammates of the user the content of the indication may indicate that the user is out of the office on vacation. In one or more implementations, the level of detail included in the content of the indication may be determined based at least in part on how closely the user is related and/or associated with the one or more other users, and/or the manner in which the user is related and/or associated with the one or more other users.

In block 410, the server 110 provides the indications of the availability status update of the user on the calendars of the determined users using the content of the indications that corresponds to the user relation criterion satisfied by each of the determined users. Thus, the content of the indication provided on a calendar of a first user may differ from the content of the indication provided on a calendar of a second user. In block 412, the server 110 determines whether any status updates are necessitated or triggered by the availability status update of the user, such as an email status update, a messaging status update, and/or a time accounting status update. For example, an availability status update to indicate that the user is in a meeting may necessitate a messaging status update, but not an email status update; however, an availability status update to indicate that the user will be out of the office may necessitate both an email status update and a messaging status update, and possibly also a time accounting status update. In one or more implementations, the server 110 may automatically determine that one or more status updates are necessitated when the availability status update indicates that the user will be unavailable, such as out of the office, for a threshold amount of time.

If, in block 412, the server 110 determines that an email status update is necessitated by the availability status update, the server 110 moves to block 414. In block 414, the server 110 updates the email status of the user via the email module 208 based at least in part on the availability status update, such as to send appropriate out-of-office auto-replies. If, in block 412, the server 110 determines that a messaging status update is necessitated by the availability status update, the server 110 moves to block 416. In block 416, the server 110 updates the messaging service status and/or messaging status messages, based at least in part on the availability status update, and via the messaging module 212. If, in block 412, the server 110 determines that a time accounting status update is necessitated by the availability status update, the server 110 moves to block 418. In block 418, the server 110 updates the time accounting module 214 based at least in part on the availability status update.

FIG. 5 illustrates a flow diagram of an example process 500 for a system supporting selective notification of user availability status in accordance with one or more implementations. For explanatory purposes, the example process 500 is primarily described herein with reference to server 110 of FIGS. 1 and 2; however, the example process 500 is not limited to the server 110 of FIGS. 1 and 2, and the example process 500 may be performed by one or more components of the server 110, such as, for example, one or more of the team and contacts processor 202 and/or modules 204-214. Further for explanatory purposes, the blocks of the example process 500 are described herein as occurring in serial, or linearly. However, multiple blocks of the example process 500 may occur in parallel. In addition, the blocks of the example process 500 may be performed a different order than the order shown and/or one or more of the blocks of the example process 500 may not be performed.

In block 502, the server 110 receives an update to the organizational structure of the organization. In block 504, the server 110 updates the calendars of the users, such as the calendars 304A-C, based at least in part on the update to the organizational structure of the organization. For example, if a user has changed teams, changed management responsibilities, etc., the server 110 removes, from the user's calendar, the availability statuses corresponding to the users of the previous teams/management responsibilities, and adds, to the user's calendar, the availability statuses corresponding to the users of the new teams/management responsibilities.

FIG. 6 illustrates a flow diagram of an example process 600 for a system supporting selective notification of user availability status in accordance with one or more implementations. For explanatory purposes, the example process 600 is primarily described herein with reference to server 110 of FIGS. 1 and 2; however, the example process 600 is not limited to the server 110 of FIGS. 1 and 2, and the example process 600 may be performed by one or more components of the server 110, such as, for example, one or more of the team and contacts processor 202 and/or modules 204-214. Further for explanatory purposes, the blocks of the example process 600 are described herein as occurring in serial, or linearly. However, multiple blocks of the example process 600 may occur in parallel. In addition, the blocks of the example process 600 may be performed a different order than the order shown and/or one or more of the blocks of the example process 600 may not be performed.

In block 602, the server 110 receives a request for a calendar of a user within an organization, such as from a user interacting with a calendar application executing on one of the electronic devices 102, 104, 106. In block 604, the server 110 determines other users in the organization whose availabilities are likely of interest to the user. For example, the server 110 may retrieve organizational structure information from the organizational structure module 206 and may identify users who are directly and/or indirectly related and/or associated with the user in the organizational structure information. In one or more implementations, the server 110 may also determine users whose availabilities are likely of interest to the user based on messaging and/or email histories of the user, and/or other factors or criteria.

In block 606, the server 110 retrieves availabilities of the determined users from an aggregate calendar 302 of the organization. For example, the server 110 may retrieve the availabilities of the determined users from the aggregate calendar via the calendar module 204. In block 608, the server 110 determines content of the indications of the availabilities of the determined users based at least in part on the user's relationships and/or associations with the determined users. For example, an indication may include additional detail when the user has a close association and/or relationship with a determined user, and/or the amount of detail may be dependent upon the type of association/relationship that the user has with the determined user. Alternatively, and/or in addition, the indications may include different content for different relationships/associations between the user and each of the determined users.

In block 610, the server 110 populates the calendar of the user with the indications of the availabilities of the determined users and the appropriate content thereof. In block 612, the server 110 provides the calendar, including the indications of the availabilities of the determined users, to the user for display, such as via one of the electronic devices 102, 104, 106. In one or more implementations, the server 110 and/or the calendar module 204 may generate and maintain the calendar of the user and the user availability statuses contained therein, such as in a memory. The server 110 may then retrieve the calendar of the user from the memory and provide the calendar for display to the user.

FIG. 7 illustrates an example organizational structure 700 in a system for selective notification of user availability status in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The organizational structure 700 indicates the associations/relationships between employees of an organization and/or additional outside contacts. The organizational structure 700 includes levels n, n+1, n+2, n−1, and n−2. The level n contains the user and the user's peers, such as outside contacts, collaborators, co-workers, teammates, etc. The level n+1 includes the user's manager(s), e.g. manager #1 and manager #2. The level n+2 includes the user managers' manager(s). The level n−1 includes the user's direct report(s), e.g. employees who report directly to the user. The level n−2 includes the user's indirect report(s), e.g. employees who report directly to the user's direct reports but not directly to the user. As shown in the organizational structure 700, the user may have a direct relationship and/or association with the employees who are on the same level as the user, or one level above or below the level of the user. Furthermore, the user may have an indirect relationship and/or association with employees who are related and/or associated with the user through another employee, e.g. the related employees two or more levels above or below the level of the user. In one or more implementations, a user may not have a relationship with a person on the n+1 level (e.g. a manager) or a person on the n+2 level (e.g. a manager's manager) when, for example, the user is the owner of the company. Similarly, a user may not necessarily have any direct reports or indirect reports if they are not managing other organization members.

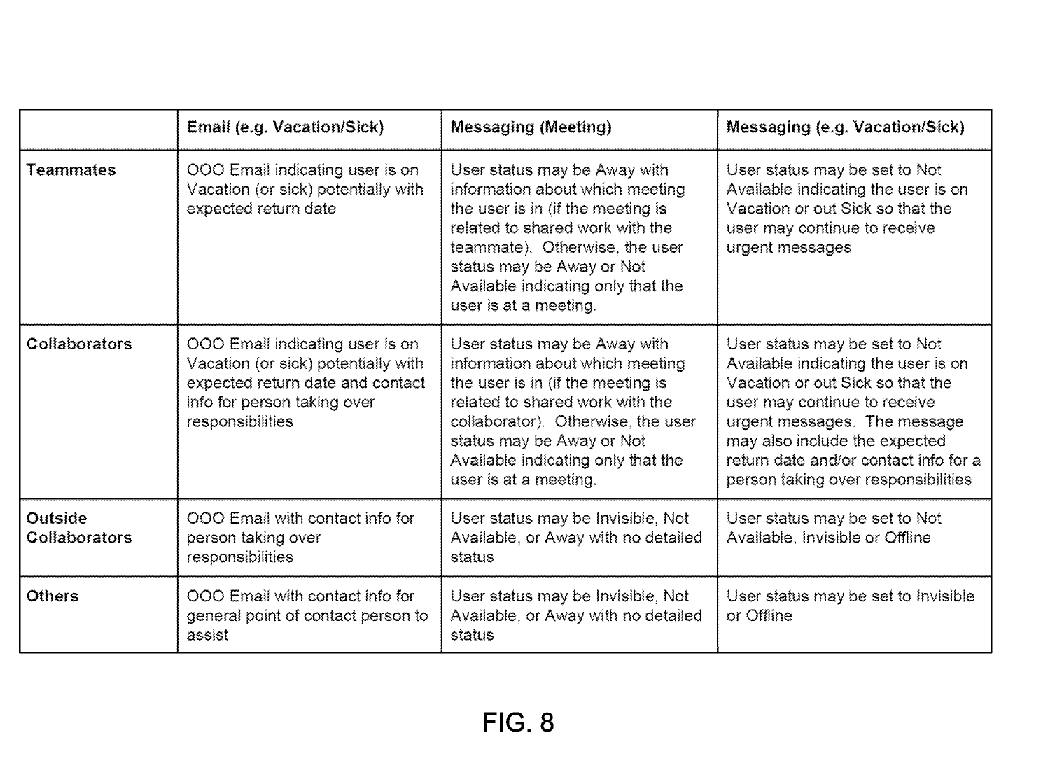

FIG. 8 illustrates example email and messaging status content in a system for selective notification of user availability status in accordance with one or more implementations. As shown in FIG. 8, the content of out-of-office emails for a user may vary based at least in part on a relation of the user to the recipient of the out-of-office email. For example when the user is on vacation (or sick), teammates of the user may receive an out-of-office email indicating that the user is on vacation (or sick). In one or more implementations, the out-of-office email may include an expected return date based upon the user's calendar. For example, if the user set their vacation status to end in five days, the out-of-office email may automatically identify the first following business day for that user and include that date in the out-of-office email. So if a user set their vacation status for December 19-24 then the system could identify December 27 as their return date if the company or user's country provides December 25 and 26 as holidays, or if December 25 and 26 are weekend days. Similarly, if a user set their vacation status for Monday through Friday, then the system could identify the following Monday (assuming it is a workday) as the return date. Collaborators of the user may receive an out-of-office email indicating that the user is on vacation (or sick). In one or more implementations, the out-of-office email may include an expected return date and information for contacting a person taking over the user's responsibilities. Outside collaborators of the user, e.g. collaborators of the user that are outside of the user's organization and/or company, may receive an out-of-office email that includes contact information for the person taking over the user's responsibilities. Other persons may receive an out-of-office email with contact information for a general point of contact person to assist.

Further as shown in FIG. 8, the content of the messaging status for the user that is provided to a third party may vary depending on the user's relation to the third party. For example when the user is in a meeting, for teammates of the user, the user's messaging status may be “Away” and may include information about which meeting the user is in (if the meeting is related to shared work with the teammate). Otherwise, the user's messaging status for teammates of the user may be “Away” or “Not Available” and may indicate generally that the user is at a meeting. For collaborators of the user, the user's messaging status may be “Away” and may include information about which meeting the user is in (if the meeting is related to shared work with the collaborator). Otherwise, the user's messaging status for collaborators of the user may be “Away” or “Not Available” and indicating generally that the user is at a meeting. For outside collaborators and other persons, the user's messaging status may be “Invisible,” “Not Available,” or “Away” without any detailed status information.

In another messaging example when the user is on vacation (or sick), for teammates of the user, the user's messaging status may be “Not Available” and may indicate that the user is on vacation or out sick so that the user may continue to receive urgent messages. For collaborators of the user, the user's messaging status may be “Not Available” and may indicate that the user is on vacation or out sick so that the user may continue to receive urgent messages. The messaging status may also include an expected return date and/or contact information for a person taking over the user's responsibilities. For outside collaborators, the user's messaging status may be “Not Available,” “Invisible,” or “Offline.” For other persons, the user's messaging status may be “Invisible,” or “Offline.”

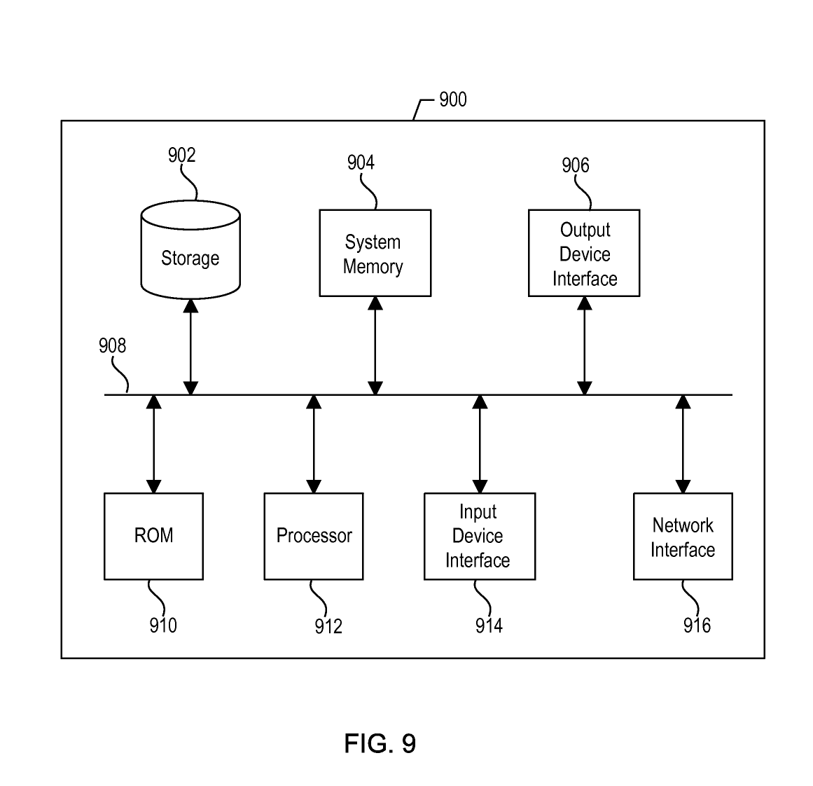

FIG. 9 conceptually illustrates electronic system 900 with which any implementations of the subject technology may be implemented. Electronic system 900, for example, can be a desktop computer, a laptop computer, a tablet computer, a server, a receiver, a phone, or generally any electronic device. Such an electronic system 900 includes various types of computer readable media and interfaces for various other types of computer readable media. Electronic system 900 includes bus 908, processing unit(s) 912, system memory 904, read-only memory (ROM) 910, permanent storage device 902, input device interface 914, output device interface 906, and network interface 916, or subsets and variations thereof.

Bus 908 collectively represents all system, peripheral, and chipset buses that communicatively connect the numerous internal devices of electronic system 900. In one or more implementations, bus 908 communicatively connects processing unit(s) 912 with ROM 910, system memory 904, and permanent storage device 902. From these various memory units, processing unit(s) 912 retrieves instructions to execute and data to process in order to execute the processes of the subject disclosure. The processing unit(s) can be a single processor or a multi-core processor in different implementations.

ROM 910 stores static data and instructions that are needed by processing unit(s) 912 and other modules of the electronic system. Permanent storage device 902, on the other hand, is a read-and-write memory device. This device is a non-volatile memory unit that stores instructions and data even when electronic system 900 is off. One or more implementations of the subject disclosure use a mass-storage device (such as a magnetic or optical disk and its corresponding disk drive) as permanent storage device 902.

Other implementations use a removable storage device (such as a floppy disk, flash drive, and its corresponding disk drive) as permanent storage device 902. Like permanent storage device 902, system memory 904 is a read-and-write memory device. However, unlike storage device 902, system memory 904 is a volatile read-and-write memory, such as random access memory. System memory 904 stores any of the instructions and data that processing unit(s) 912 needs at runtime. In one or more implementations, the processes of the subject disclosure are stored in system memory 904, permanent storage device 902, and/or ROM 910. From these various memory units, processing unit(s) 912 retrieves instructions to execute and data to process in order to execute the processes of one or more implementations.

Bus 908 also connects to input and output device interfaces 914 and 906. Input device interface 914 enables a user to communicate information and select commands to the electronic system. Input devices used with input device interface 914 include, for example, alphanumeric keyboards and pointing devices (also called “cursor control devices”). Output device interface 906 enables, for example, the display of images generated by electronic system 900. Output devices used with output device interface 906 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, bus 908 also couples electronic system 900 to a network (not shown) through network interface 916. In this manner, the computer can be a part of a network of computers (such as a local area network (“LAN”), a wide area network (“WAN”), or an Intranet, or a network of networks, such as the Internet. Any or all components of electronic system 900 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method for selective notification of user availability status, the method comprising:
receiving an availability status update of a user for a period of time;
updating an aggregate calendar with the availability status update of the user for the period of time, wherein the aggregate calendar includes availability statuses of a set of users that includes the user;
determining, using one or more processors, at least one user of the set of users that is likely to be interested in the availability status update of the user based at least in part on a user relation criterion; and
providing an indication of the availability status update of the user for the period of time on a calendar of the at least one user of the set of users.

2. The computer-implemented method of claim 1, wherein the availability status update of the user for the period of time indicates that the user will be out-of-office for the period of time.

3. The computer-implemented method of claim 1, wherein determining, using the one or more processors, the at least one user of the set of users that is likely to be interested in the availability status update of the user based at least in part on the user relation criterion comprises:
determining, using the one or more processors, the at least one user of the set of users that is likely to be interested in the availability status update of the user based at least on whether the at least one user is directly or indirectly associated with the user in an organizational structure that indicates associations of the set of users in an organization.

4. The computer-implemented method of claim 3, wherein the at least one user is associated with the user in the organizational structure as at least one of a manager of the user, a direct report of the user, or a teammate of the user.

5. The computer-implemented method of claim 3, wherein a content of the indication of the availability status update of the user is determined based at least on part on a type of association between the user and the at least one user in the organizational structure.

6. The computer-implemented method of claim 5, wherein the content identifies an alternate contact that is determined based at least in part on the type of the association between the user and the at least one user.

7. The computer-implemented method of claim 1, wherein determining, using the one or more processors, the at least one user of the set of users that is likely to be interested in the availability status update of the user based at least in part on the user relation criterion comprises:
determining, using the one or more processors, the at least one user of the set of users that is likely to be interested in the availability status update of the user based at least on whether the at least one user is a collaborator of the user.

8. The computer-implemented method of claim 1, wherein determining, using the one or more processors, the at least one user of the set of users that is likely to be interested in the availability status update of the user based at least in part on the user relation criterion comprises:
determining, using the one or more processors, the at least one user of the set of users that is likely to be interested in the availability status update of the user based at least on a first frequency at which the at least one user contacts the user or a second frequency at which the user contacts the at least one user.

9. The computer-implemented method of claim 8, further comprising:
determining, using the one or more processors, the first frequency or the second frequency based at least in part on an email history or an instant messaging history of the user.

10. The computer-implemented method of claim 8, wherein a content of the indication of the availability status update of the user is determined based at least in part on the first frequency or the second frequency.

11. A device comprising:
at least one processor circuit that is configured to:
receive a request for a calendar of a user of a plurality of users of an organization;
determine a subset of the plurality of users whose availabilities are of interest to the user based at least in part on a structure of the organization;
retrieve the availabilities of the subset of the plurality of users from an aggregate calendar for the plurality of users of the organization;
populate the calendar of the user with indications of the availabilities of the subset of the plurality of users exclusive of other users of the plurality of users; and
provide, for display, the calendar of the user.

12. The device of claim 11, wherein the at least one processor circuit is further configured to:
determine the subset of the plurality of users whose availabilities are of interest to the user based at least in part on the structure of the organization and a frequency at which the user corresponds with each of the plurality of users.

13. The device of claim 12, wherein the at least one processor circuit is further configured to:
determine a content of the indication of the availability of each user of the subset of the plurality of users based at least in part on the frequency at which the user corresponds with each user of the subset of the plurality of users.

14. The device of claim 11, wherein at least one of the indications of at least one of the availabilities of at least one user of the subset of the plurality of users indicates that the at least one user of the plurality of users is out-of-office.

15. A non-transitory machine readable medium embodying instructions that, when executed by a machine, cause the machine to perform a method comprising:
receiving an availability status update from a user of a plurality of users of an organization;
filtering the plurality of users to identify a subset of the plurality of users that are directly or indirectly associated with the user in an organizational structure of the organization;
determining a plurality of recent contacts of the user that are distinct from the subset of the plurality of users; and
providing a calendar update that reflects the availability status update of the user to the subset of the plurality of users and the plurality of recent contacts.

16. The non-transitory machine readable medium of claim 15, wherein the method further comprises:
updating a calendar of at least one of the subset of the plurality of users or at least one of the plurality of recent contacts to reflect the availability status update of the user.

17. The non-transitory machine readable medium of claim 15, wherein the availability status update comprises an out-of-office update.

18. The non-transitory machine readable medium of claim 15, wherein the method further comprises:
setting an out-of-office email status for the user.

19. The non-transitory machine readable medium of claim 18, wherein the out-of-office email comprises a first content for the subset of the plurality of users and a second content for the plurality of recent contacts.

20. The non-transitory machine readable medium of claim 15, wherein the method further comprises:
receiving an update to the organizational structure of the organization; and
updating a plurality of calendars of at least some of the plurality of users of the organization based at least in part on the update to the organizational structure of the organization.
